(19) United States
(12) Patent Application Publication
(10) Pub. No.: US 2005/0127195 A1
(43) Pub. Date: Jun. 16, 2005

(54) Mixed water delivery unit with improved delivery control

(76) Inventors: Natalino Malasorti, Casoni Di Mussolente (IT); Tiberio Cerato, Enego (IT); Mario Tessarollo, Bassano Del Grappa (IT)

Correspondence Address: Dykema Gossett, Suite 300 West, 1300 I Street NW, Washington, DC, 20005-3306, US

(21) Appl. No.: 10/503,240

(22) PCT Filed: Feb. 6, 2003
(86) PCT No.: PCT/EP03/01168

(30) Foreign Application Priority Data
Feb. 11, 2002 (IT) V12002A000025

(51) Int. Cl. G05D 23/13

(52) U.S. Cl. 236/12.16

(57) ABSTRACT

A mixed water delivery unit (1) comprising a hot and cold water mixer (2), a spout (3) for the distribution of mixed water, and a handle (4) for operating said mixer (2), that can be grasped by the user's hand and connected to a pin (8) which protrudes from said mixer (2) and which is mechanically connected to the mixing members found inside said mixer (2). The handle (4) is connected to said pin (8) through a gear (9).

The invention is about a mixed water delivery unit with improved delivery control, especially fit to be employed in sanitary water delivery apparatuses.

It is well known that mixed water delivery units basically consist of a mixer equipped with hot and cold water inlet ways coming from the distribution network, with at least one mixed water outlet way connected to a spout and with a projecting pin, associated to internal mixing devices, connected to an operative handle available to the user.

Such previously described embodiment of the state of the art delivery units, has the inconvenience that the direct connection between the handle and the projecting pin makes the operation not very sensitive and therefore a fine delivery adjustment becomes very difficult.

Furthermore in order to assemble the delivery unit in the state of the art embodiments, first the mixer's ways are connected to the terminals of the distribution network and of the delivery device which are built in the wall and thus, once the connection has been carried out, everything is sealed with mortar and the plastering or some other coat is applied.

Once the assembly is completed, the mixer's part that houses the mixing members together with the corresponding pin to which the handle is applied protrudes from the wall.

Those previously described spouts available on the market, have the problem that in the case of a needed substitution of the whole delivery unit or even just the mixer, it is necessary to demolish the wall at the embedding point.

In addition, after the substitution, the recess made in the wall must be sealed with mortar and the plastering or coating must be applied all over again.

It is obvious that such operation forces the user to meet the frequently excessive expenses, taking into consideration the high labor costs charged by the field's technicians.

Furthermore the user must also cope with the hassles caused by the execution of wall demolition operations inside an apartment.

The present invention's object is that of remedying to said inconveniences.

More specifically, a first object of the invention is that of making a mixed water delivery unit which allows adjusting the delivery with greater sensibility.

Another object of the invention is to provide a delivery unit that can be removed and replaced without having to touch the wall structures.

A further object consists in making the delivery unit assembly easier and faster than matching state of the art delivery units.

The abovementioned objects are accomplished by a mixed water delivery unit which, according to the main claim, comprises the following:
a mixer having a first hot water inlet way, a second cold water inlet way and a third mixed water outlet way;
a spout for the distribution of said mixed water;
a first fitting pipe which connects said first inlet way with a hot water feeding pipe;
a second fitting pipe which connects said second inlet way with a cold water feeding pipe;
a third fitting pipe which connects said third outlet way with a pipe connected to said delivery device;
a handle for operating said mixer, that can be grasped by the user's hand and connected to a pin which protrudes from said mixer and which is mechanically connected to the mixing members found inside said mixer, and that is also characterized in that said handle is connected to said pin through at least one gear, said at least one gear comprising a bevel gear pair consisting of a first conical toothing pinion keyed fixed to the pin of said mixer which meshes with a second conical toothing pinion having a pivot pin which is connected to the handle and supported by a bearing element.

According to a preferred embodiment described hereafter, the gear comprises a bevel gear pair made of a first conical toothing pinion coupled to said mixer's pin which meshes with a second conical toothing pinion having the pivot pin coupled to the handle.

The gear, the mixer and possibly the spout as well, are supported by a single flange from which the handle for the mixer's operation protrudes.

The flange is removably applied for closing a recess made out of a bearing structure wherein the gear, the mixer and the fitting pipes are built in.

The fitting pipes which connect the mixer to the hot and cold water supply network and to the pipe feeding the delivery device are hoses.

In a further embodiment, the flange is removably applied to the opening of a box that houses the gear, the mixer and the fitting pipes and which is also inserted into the recess made out of the bearing structure.

Advantageously, the presence of the gear makes the adjustment more sensible.

Yet more advantageously, the use of the flange which supports the gear, the mixer and the fitting pipes makes the delivery unit disassembly easier because it is no longer necessary to carry out wall demolitions.

Said advantages and objects are achieved thanks to a mixed water delivery unit which is described with reference to the annexed drawing sheets, wherein:

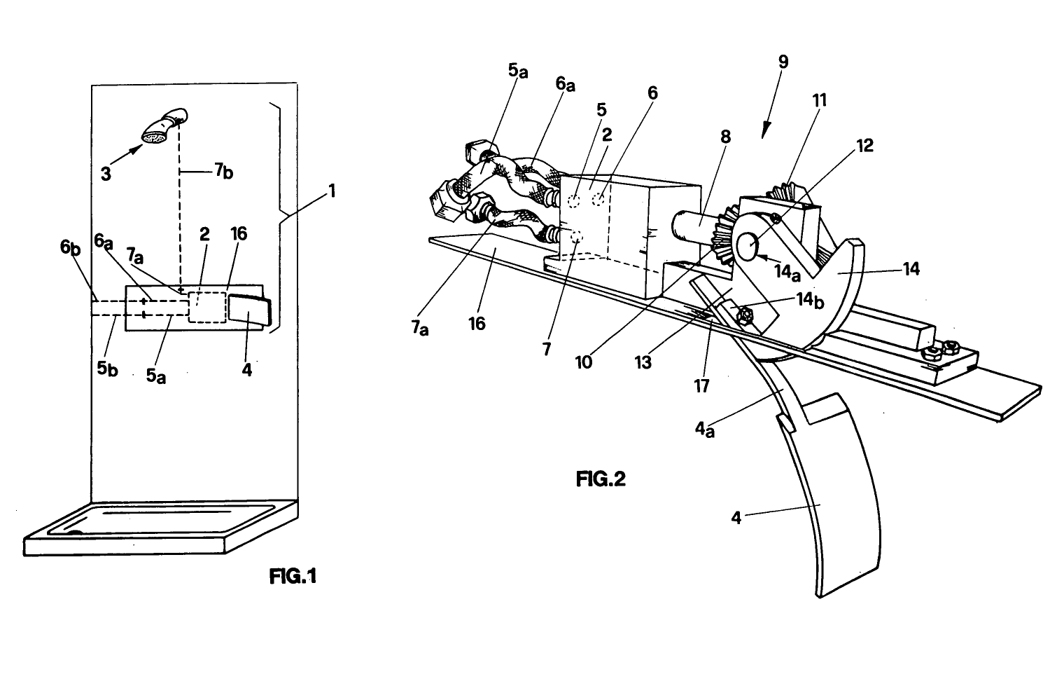

FIG. 1 is an isometric view of the application of the invention's delivery unit;

FIG. 2 is an isometric view of part of the delivery unit of FIG. 1;

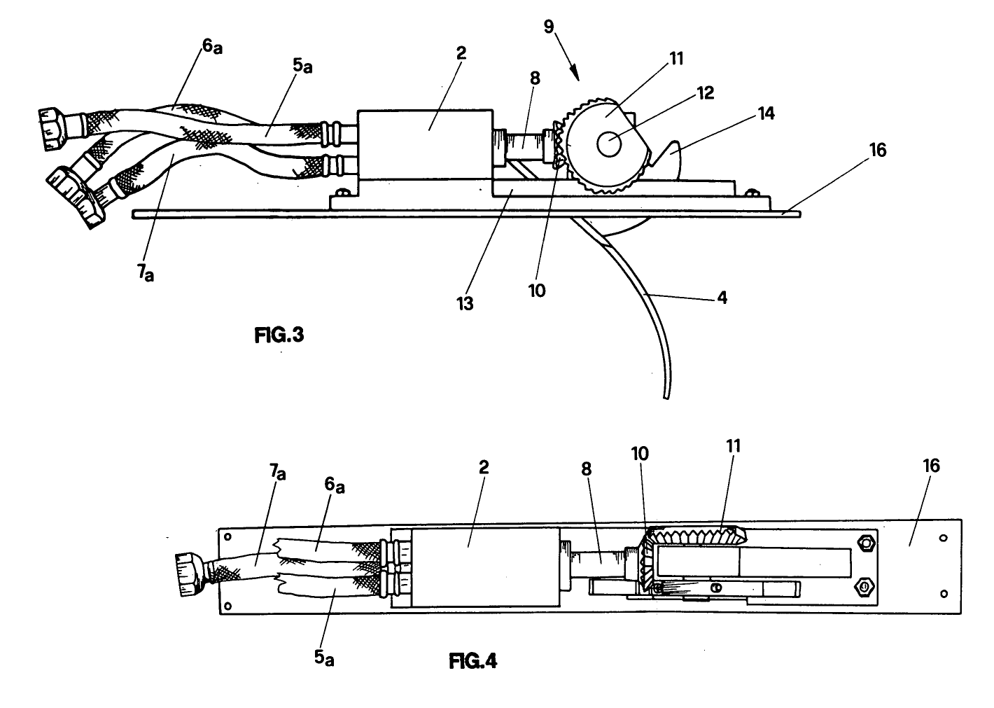

FIG. 3 is a side view of the part of the delivery unit of FIG. 2;

FIG. 4 is a top view of the part of the delivery unit of FIG. 2;

FIG. 5 is an enlarged isometric view of the part of the delivery unit of FIG. 2 during the assembly;

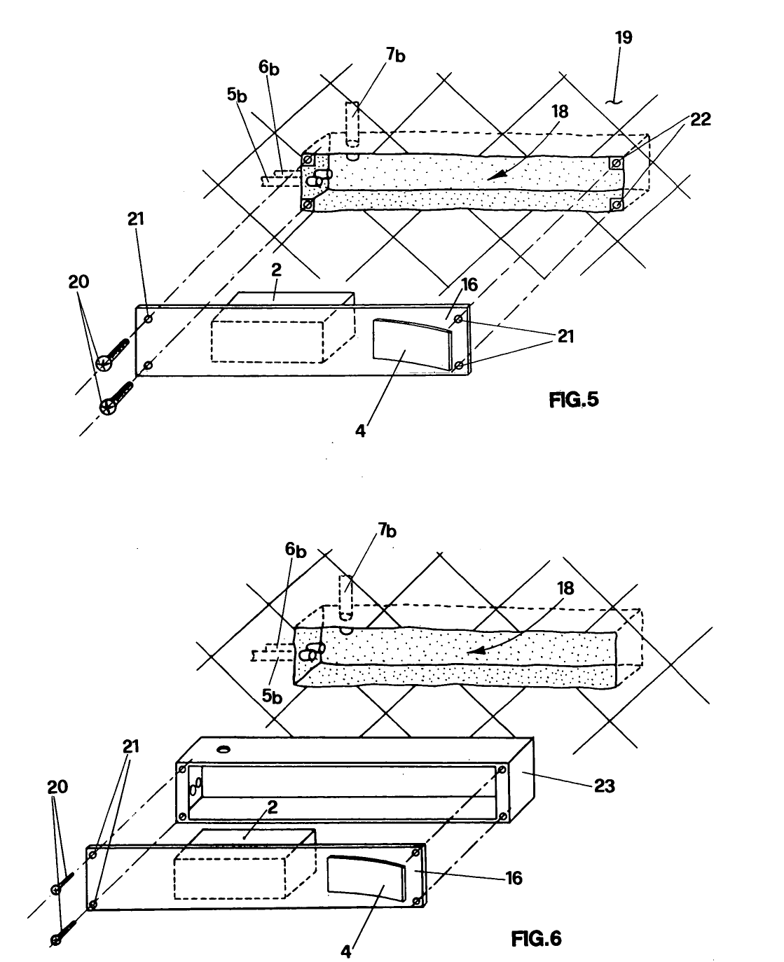

FIG. 6 is an enlarged isometric view of the part of the delivery unit of FIG. 2 in an operative embodiment during the assembly;

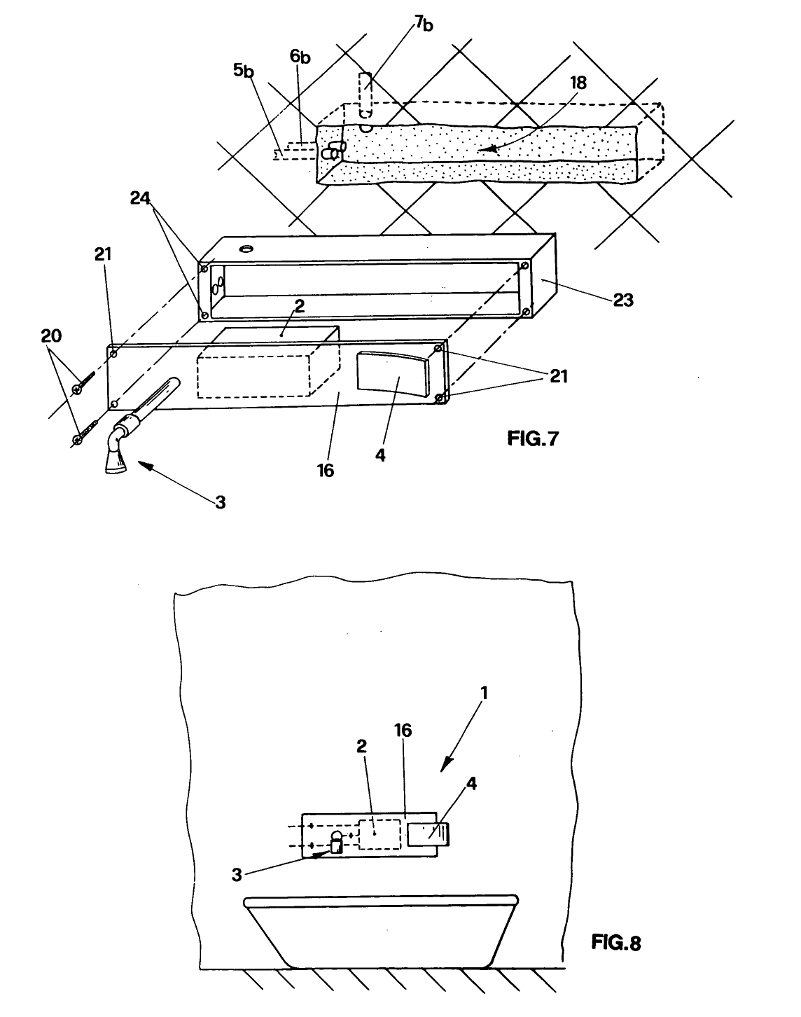

FIG. 7 is an enlarged isometric view of a further operative embodiment of the invention's delivery unit during the assembly; and

FIG. 8 shows an installation variation of an embodiment of the invention's delivery unit.

The invention's delivery unit is represented by one of its embodiments as shown in FIG. 1 where it is generally indicated with the number 1.

It must be noticed that the delivery unit essentially comprises a hot and cold water mixer 2, a mixed water spout 3 hydraulically connected to the mixer 2, and an operative handle 4 for controlling the delivery.

It is obvious that the spout 3, in this case represented by a shower head, can be of any type, size or shape.

More particularly, it can be seen in FIGS. 2 to 4 that in the mixer 2 there are: a first hot water inlet way 5, a second cold water inlet way 6, a third mixed water outlet way 7 and a pin 8 which protrudes from the body of the mixer 2. The pin 8 is mechanically connected to the mixing members found inside of the mixer, and a handle 4 is connected to such pin.

It must be specified that the mixer 2 is itself a state of the art component available on the market which, however made of different shapes and sizes, is used by all delivery units of the known kind.

In the specific described case, the mixer has a pin 8 which is made rotate around the longitudinal axis X through the handle 4.

With reference to the abovementioned figures, it is described that the first inlet way 5 and the second inlet way 6 are connected through a first fitting pipe 5a and a second fitting pipe 6a respectively to a hot water feeding pipe 5b and to a cold water feeding pipe 6b which belong to the distribution network of the hydraulic plant. In a similar manner, the third mixed water outlet way 7 is connected through a fitting pipe 7a to a pipe 7b connected to the spout 3.

According to the invention, the operative handle 4 is connected to the pin 8 of the mixer 2 through at least one gear 9.

The presence of the gear 9 transmits rotation of the handle 4 to the pin 8 with a gear ratio variable with respect to the number of teeth of the gearwheels which make up the gear 9.

This facilitates a greater delivery control, which is more precise when the gear ratio stepping-down towards the pin 8 is greater.

More particularly, it is described in FIGS. 2 to 4 that the gear 9 comprises a bevel gear pair consisting of a first conical toothing pinion 10 keyed to the pin 8 which meshes with a second conical toothing pinion 11 having a pivot pin 12 mechanically connected to the handle 4 and supported by a bearing element 13 connected to the mixer 2.

More specifically, the handle 4 is connected to the pin 12 of the second conical gear 11 through a shaped connecting rod 14 which has a through hole 14a coupling to the pin 12 and to an appendix 14b that is joined to the handle 4 through a screw 15.

It is obvious that in a different embodiment the handle 4 and the connecting rod 14 can form a single body and can take up any shape or size.

It is described again in said FIGS. 2 to 4 that the mixer 2, the gear 9 and the bearing element 13 are connected to a flange 16 wherein a slit 17 is made through which the appendix 14b of the connecting rod 14 protrudes as well as the appendix 4a of the handle 4 whereon said flange is applied.

The bearing flange 16, as shown in FIG. 5, is arranged for closing a recess 18 made out of a bearing structure 19, which houses a built in mixer 2 and the fitting pipes 5a, 6a, 7a, the gear 9 and the bearing element 13.

The bearing flange 16 is applied for closing the recess 18 through removable connecting means which comprise screws 20, each one of them is arranged as a passing through hole 21 made in the bearing flange 16 and it is housed in a matching nut screw 22 found in the recess 18.

It must be specified that such nut screws 22 can be installed inside the recess 18 during its operation.

According to an operative embodiment that is described in FIG. 6, the delivery unit 1 comprises also a box 23, slidably insertable into the recess 18, wherein the mixer 2, the fitting pipes 5a, 6a, 7a, the gear 9 and the bearing element 13 are housed when the bearing flange 16 is arranged for closing the box 23.

A further operative embodiment is illustrated in FIG. 7 and differs from the previously described embodiments because the bearing flange 16 supports also the spout 3 which gets fixed to it.

It is clear that such operative embodiment with the spout 3 applied to the flange 16 can provide that the flange were arranged either for closing the box 23 as described in FIG. 7, or for directly closing the recess 18.

In the case wherein the spout 3 belongs to the bearing flange 16, an assembly embodiment could be, as an example, that shown in FIG. 8.

Based on what has been previously described it seems clear that the invention's delivery unit, in all the presented embodiments, accomplishes the pre-established objects.

As a matter of fact, after having made the recess 18 into the bearing structure 19, it is enough to link the pipes which connect the mixer 2 to the distribution network and to the spout 3 and thus applying the bearing flange 16 directly to the recess 18 or to a box 23, in this case before the insertion of the latter into the recess 18.

Based on what has been described so far, it is thus clear that the invention's spout achieves the pre-established objects.

More specifically, the presence of the gear 9 makes the adjustment more precise because the rotation of the pin 8 which controls the mixer 2 is more easily controllable through the movement of the handle 4.

Furthermore, varying in a proper manner the gear ratio and hence the diameters of the bevel gears 10 and 11 meshed with one another that make up the gear 9, it is possible to vary the gear ratio and therefore the ratio between the movement of the handle and the angular rotation of the protruding shaft 8 of the mixer 2. In other words, it is possible to link in different ways the extent of the operative handle's movement and the delivery's opening.

Furthermore, the presence of the supporting hanger 16 whereon the mixer 2, the gear 9 and the support 13 are applied, makes the disassembly and the replacement of the delivery unit quicker and less expensive compared to the traditional spouts. As a matter of fact, after the bearing flange 16 has been removed from either the recess 18 or the corresponding box 23, it is enough to disconnect the flexible pipes in order to carry out the replacement.

Obviously, as previously said, the spout 3 can be of any kind or shape.

In the operative phase, embodiments fit to make both the assembly and the building easier can be applied to the invention's delivery unit.

When said operative embodiments that have not been described or illustrated in the annexed drawings fall within the scope of protection of the following claims, they should be covered by the present patent.

1. A mixed water delivery unit comprising:
a mixer having a first hot water inlet way, a second cold water inlet way, a third mixed water outlet way;
a spout for the distribution of said mixed water;
a first fitting pipe which connects said first way to a hot water feeding pipe;
a second fitting pipe which connects said second way to a cold water feeding pipe;
a third fitting pipe which connects said third way a to a pipe connected to said spout;
a handle for operating said mixer, that can be grasped by the user's hand and connected to a pin which protrudes from said mixer and which is mechanically connected to the mixing members found inside said mixer, wherein said handle is connected to said pin through at least one gear, said at least one gear comprising a bevel gear pair consisting of a first conical toothing pinion keyed fixed to the pin of said mixer which meshes with a second conical toothing pinion having a pivot pin which is connected to the handle and supported by a bearing element.

2. The delivery unit according to claim 1, wherein said mixer and said at least one gear are applied to a bearing flange from which said handle protrudes, said bearing flange being arranged for closing a recess made out of a bearing structure and fit to house said built in mixer, said fitting pipes, and said gear.

3. The delivery unit according to claim 1, wherein said handle is connected to said pin through a shaped connecting rod having a through hole coupling to said pin and to an appendix which is linked to a matching appendix of said handle through a screw.

4. The delivery unit according to claim 1, wherein said bearing element is connected to said mixer.

5. The delivery unit according to claim 3, wherein said appendix of said handle and said appendix of said shaped connecting rod are arranged passing through a slit made inside said bearing flange.

6. The delivery unit according to claim 2, wherein it comprises a box which is inserted into said recess and wherein said mixer, said fitting pipes, and said gear are inserted as well when said bearing flange is arranged for closing said box.

7. The delivery unit according to claim 1, wherein said fitting pipes are flexible pipes.

8. The delivery unit according to claim 2, wherein said bearing flange is applied for closing said recess through removable connecting means that comprise screws arranged as passing through holes made in said flange which are coupled into matching nut screws associated to said recess.

9. The delivery unit according to claim 6, wherein said bearing flange is applied for closing said box through removable connecting means that comprise screws arranged as passing through holes made in said flange which are coupled into matching lead screws associated to said box.

10. The delivery unit according to claim 2, wherein said bearing flange is also connected to said spout (3).
